(19) United States
(12) Patent Application Publication
(10) Pub. No.: US 2024/0359094 A1
(43) Pub. Date: Oct. 31, 2024

(54) METHOD, APPARATUS, READABLE MEDIUM, AND ELECTRONIC DEVICE FOR CLOUD GAME INTERACTION

(71) Applicant: Beijing Bytedance Network Technology Co., Ltd., Beijing (CN)

(72) Inventor: Ke TIAN, Beijing (CN)

(21) Appl. No.: 18/579,785

(22) PCT Filed: Oct. 14, 2022
(86) PCT No.: PCT/CN2022/125467

§ 371 Date: Jan. 16, 2024

(30) Foreign Application Priority Data
Nov. 17, 2021 (CN) 202111362721.3

(51) Int. Cl. A63F 13/52

(52) U.S. Cl. CPC A63F 13/52; A63F 2300/308

(57) ABSTRACT

The present disclosure relates to method, apparatus, readable medium, and electronic device for cloud game interaction. The method includes: displaying an interface of a target cloud game; acquiring, in response to a trigger operation on the interface of the target cloud game, contents associated with the target cloud game through a preset data channel; and presenting the associated contents on a preset presentation area of the interface of the target cloud game.

The present disclosure claims priority to Chinese Patent Application No. 202111362721.3 filed on Nov. 17, 2021 and entitled “METHOD, APPARATUS, READABLE MEDIUM, AND ELECTRONIC DEVICE FOR CLOUD GAME INTERACTION”, which is incorporated herein by reference in its entirety.

### TECHNICAL FIELD

The present disclosure relates to a field of Internet technology, specifically, relates to a method, apparatus, readable medium, and electronic device for cloud game interaction.

### BACKGROUND

In recent years, with the continuous development of cloud computing technology. Cloud games, as one of the important application directions of the cloud computing technology, have received widespread attentions. At present, a player usually can only play the corresponding game after entering a cloud game. However, during the game, the player often has a need to search for required information (e.g., strategy information, video information, player information of other players, etc.).

In the related technology, when searching for the required information during the game, the player may only exit the game and search for the required information by means of an APP or a browser, which may affect normal gaming experience of the player and cause it more difficult to search for the required information.

### SUMMARY

The summary is provided in order to present the ideas in a brief form, which will be described in detail later in the detailed description. The summary is not intended to identify key features or essential features of the technical solution for which protection is claimed, nor is it intended to be used to limit the scope of the technical solution for which protection is claimed.

In a first aspect, the present disclosure provides a method for cloud game interaction, the method comprising:
displaying an interface of a target cloud game;
acquiring, in response to a trigger operation on the interface of the target cloud game, contents associated with the target cloud game through a preset data channel; and
presenting the associated contents on a preset presentation area of the interface of the target cloud game.

In a second aspect, the present disclosure provides an apparatus for cloud game interaction, the apparatus comprising:
a display module, configured to display an interface of a target cloud game;
an acquisition module, configured to acquire, in response to a trigger operation on the interface of the target cloud game, contents associated with the target cloud game through a preset data channel; and
a presentation module, configured to present the associated contents on a preset presentation area of the interface of the target cloud game.

In a third aspect, the present disclosure provides a computer-readable medium having a computer program stored thereon, when executed by a processing apparatus, the computer program implementing the steps of the method described in the first aspect of the present disclosure.

In a fourth aspect, the present disclosure provides an electronic device, comprising:
a storage apparatus, having a computer program stored thereon; and
a processing apparatus, configured to execute the computer program stored on the storage apparatus, to implement the steps of the method described in the first aspect of the present disclosure.

By the technical solutions described above, the present disclosure firstly displays an interface of a target cloud game; and acquires, in response to a trigger operation on the interface of the target cloud game, contents associated with the target cloud game through a preset data channel; and then, presents the associated contents on a preset presentation area of the interface of the target cloud game. The present disclosure may acquire the contents associated with the target cloud game directly by the trigger operation, and present on the preset presentation area, without requiring a player to exit the game to acquire the associated contents, which may avoid affecting normal gaming experience of the player, and at the same time reduce the difficulty of acquiring the associated contents.

Other features and advantages of the present disclosure will be described in detail in the subsequent detailed description.

### BRIEF DESCRIPTION OF THE DRAWINGS

The foregoing and other features, advantages, and aspects of embodiments of the present disclosure will become more apparent in conjunction with the accompanying drawings and with reference to the detailed description. Throughout the accompanying drawings, the same or similar accompanying marks indicate the same or similar elements. It should be understood that the accompanying drawings are schematic and that the components and elements are not necessarily drawn to scale. In the accompanying drawings:

FIG. 1 is a flowchart of a method for cloud game interaction illustrated according to one exemplary embodiment;

FIG. 2 is a schematic diagram of presenting the associated contents illustrated according to one exemplary embodiment;

FIG. 3 is a flowchart of step 102 illustrated according to the embodiment shown in FIG. 1;

FIG. 4 is another flowchart of step 102 illustrated according to the embodiment shown in FIG. 1;

FIG. 5 is another schematic diagram of presenting the associated contents illustrated according to one exemplary embodiment;

FIG. 6 is another schematic diagram of presenting the associated contents illustrated according to one exemplary embodiment;

FIG. 7 is another flowchart of step 102 illustrated according to the embodiment shown in FIG. 1;

FIG. 8 is another schematic diagram of presenting the associated contents illustrated according to one exemplary embodiment;

FIG. 9 is a flowchart of step 103 illustrated according to the embodiment shown in FIG. 1;

FIG. 10 is a flowchart of another method for cloud game interaction illustrated according to an exemplary embodiment;

FIG. 11 is flowchart of another method for cloud game interaction illustrated according to one exemplary embodiment;

FIG. 12 is a schematic diagram for triggering a live operation illustrated according to one exemplary embodiment;

FIG. 13 is a block diagram of an apparatus for cloud game interaction illustrated according to one exemplary embodiment;

FIG. 14 is a block diagram of the presentation module illustrated according to the embodiment shown in FIG. 13;

FIG. 15 is a block diagram of the acquisition module illustrated according to the embodiment shown in FIG. 13;

FIG. 16 is a block diagram of another presentation module illustrated according to the embodiment shown in FIG. 13;

FIG. 17 is a block diagram of another apparatus for cloud game interaction illustrated according to one exemplary embodiment;

FIG. 18 is a block diagram of another apparatus for cloud game interaction illustrated according to one exemplary embodiment; and

FIG. 19 is a block diagram of an electronic device illustrated according to one exemplary embodiment.

### DETAILED DESCRIPTION

Embodiments of the present disclosure will be described in greater detail below with reference to the accompanying drawings. Although certain embodiments of the present disclosure are shown in the accompanying drawings, it should be understood that the present disclosure may be implemented in various forms and should not be construed as being limited to the embodiments set forth herein, but rather the embodiments are provided for a more thorough and complete understanding of the present disclosure. It should be understood that the accompanying drawings and embodiments of the present disclosure are for exemplary purposes only and are not intended to limit the scope of protection of the present disclosure.

It should be understood that the various steps documented in the method embodiments of the present disclosure may be performed in a different order, and/or in parallel. Furthermore, the embodiments for the method may include additional steps and/or omit performing the illustrated steps. The scope of the present disclosure is not limited in this regard.

The term “including” and its variations are used herein as an open-ended inclusion, i.e., “including but not limited to”. The term “based on” is “based at least in part on”. The term “one embodiment” means “at least one embodiment”; the term “another embodiment” means “at least one additional embodiment”; the term “another embodiment” means “at least one other embodiment”; and the term “some embodiments” means “at least some embodiments”. Related definitions of other terms will be given in the following description.

It should be noted that the concepts of “first”, “second” and the like mentioned in the present disclosure are only used to distinguish different devices, modules or units, and are not used to define the order or interdependence of the functions performed by these devices, modules or units.

It should be noted that the modifications of “one” and “more” mentioned in the present disclosure are schematic rather than limiting, and the person skilled in the art should understand that they should be understood as “one or more” unless otherwise expressly stated in the context.

The names of the messages or information interacting between a plurality of devices of this disclosure are for illustrative purposes only and are not intended to limit the scope of those messages or information.

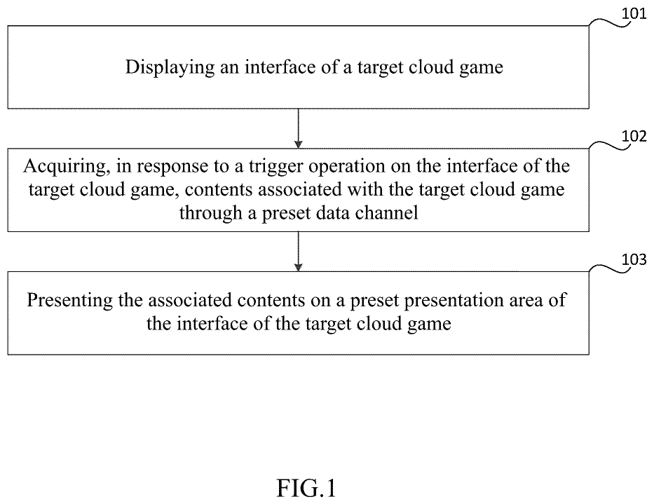

FIG. 1 is a flowchart of a method for cloud game interaction illustrated according to one exemplary embodiment. As shown in the FIG. 1, the method comprises:

Step 101: displaying an interface of a target cloud game.

To be exemplary, the cloud game is running and stored in a cloud device. The target cloud game played by the player by means of a game client on the terminal is actually a game video corresponding to the cloud game. When the player wants to play the target cloud game, he or she may utilize the client to access the target cloud game on the cloud device through an information stream, and the client transmits an operation instruction of the player for the target cloud game to the cloud device. The cloud device may then render an interface of the target cloud game for the target cloud game according to the operation instruction, and transmit the rendered interface of the target cloud game to the terminal, to display the interface of the target cloud game on a screen of the terminal. The terminal may be a mobile terminal such as a smartphone, a tablet computer, a laptop computer, or a fixed terminal such as a desktop computer, and the cloud device may be a cloud game platform, a cloud server, or the like.

Step 102: acquiring, in response to a trigger operation on the interface of the target cloud game, contents associated with the target cloud game through a preset data channel.

In this step, in order to satisfy searching needs for a player during the game, a corresponding trigger operation may be triggered by the player performing a preset operation (e.g., a clicking operation, a double-clicking operation, and a long-pressing operation, etc.) on the interface of the target cloud game displayed at the terminal according to his/her actual needs, and such a trigger operation is transmitted to the cloud device, so that the cloud device may acquire, in response to the trigger operation, contents associated with the target cloud game by the preset data channel. The preset data channel may be a channel used by the cloud device to acquire the associated contents, for example, from a host application on which the target cloud game is running, other external applications (APPs), search engines, or preset databases, which is not specifically limited in the present disclosure. The associated contents may be, for example, texts, videos, web pages, and the like related to the target cloud game.

For example, during playing the target cloud game, the player may click on a specified button on the interface of the target cloud game in order to trigger a corresponding trigger operation, and may input search text (which is used to describe information that the player is searching for) into a terminal at the same time. The searched text is transmitted to the cloud device by the client. After receiving the search text, the cloud device may search the search text by a search engine to obtain the associated contents that the player is searching for. As another example, the player may perform a trigger operation on the interface of the target cloud game, and the cloud device may perform a lookup in a preset database according to the progress of the target cloud game at the moment of occurring the trigger operation to obtain the associated contents.

Step 103: presenting the associated contents on a preset presentation area of the interface of the target cloud game.

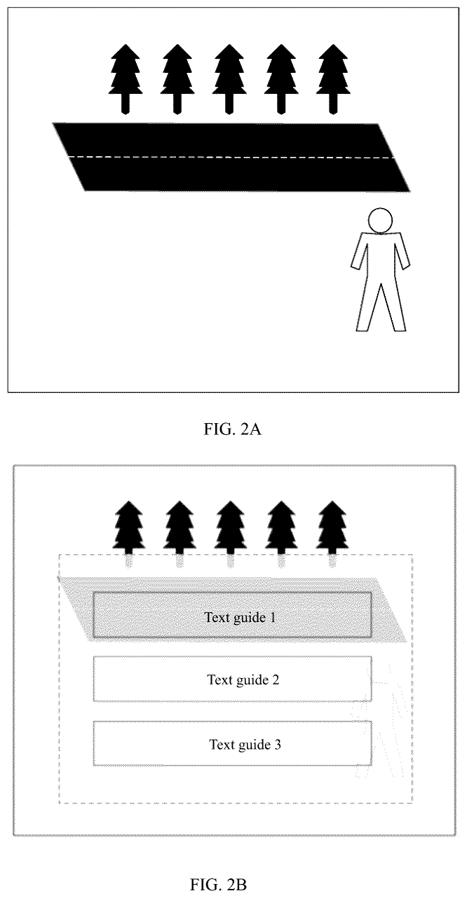

By way of example, the contents associated with the target cloud game may be presented on the preset presentation area of the interface of the target cloud game. The preset presentation area may include an obscuration. After acquiring the contents associated with the target cloud game, the obscuration may be superimposed above the interface of the target cloud game (i.e., equivalent to rendering another layer above the target cloud game interface), and the associated contents may be presented on the obscuration. For example, the interface of the target cloud game without superimposing the obscuration may be shown as (a) in FIG. 2, and when the associated contents are the text guides for the target cloud game, presenting the text guides on the obscuration may be shown as (b) in FIG. 2, wherein the area enclosed by the dotted line is the superimposed obscuration. In this way, the player can directly acquire the required information while playing the game without searching for the required information across platforms, which reduces the difficulty of searching for the required information. At the same time, the player does not need to exit the game, which can realize playing the game while viewing the required information (e.g., hanging up the game while watching video guides associated with the target cloud game), thereby avoiding affecting normal gaming experience of the player.

In summary, the present disclosure firstly displays an interface of a target cloud game; acquires, in response to a trigger operation on the interface of the target cloud game, contents associated with the target cloud game through a preset data channel; and then, displays the associated contents on a preset presentation area of the interface of the target cloud game. The present disclosure may acquire the contents associated with the target cloud game directly by the trigger operation, and display the contents on the preset presentation area, without requiring the player to exit the game to acquire the associated contents, which may avoid affecting normal gaming experience of the player, and reduce the difficulty of acquiring the associated contents at the same time.

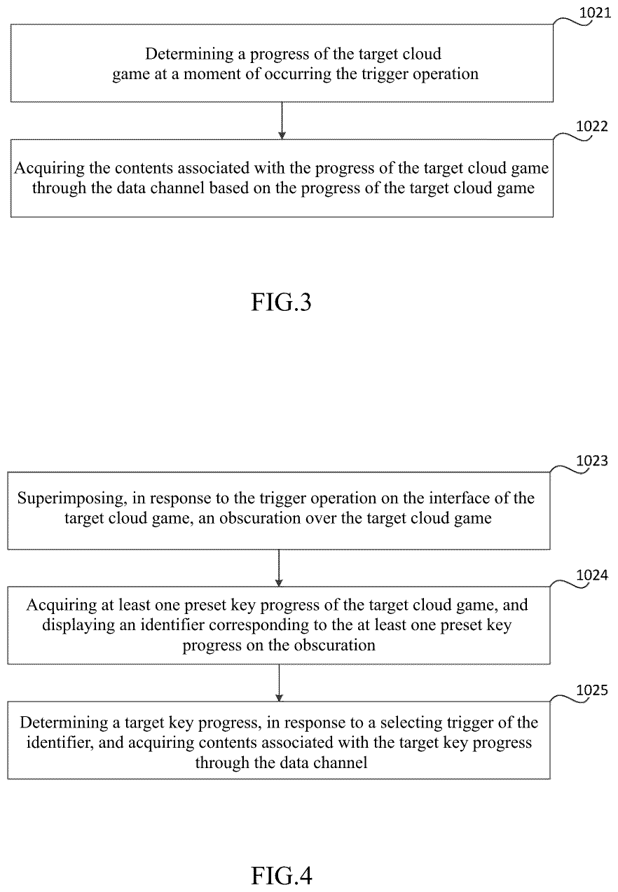

FIG. 3 is a flowchart of step 102 illustrated according to the embodiment shown in FIG. 1. As shown in FIG. 2, the step 102 may comprise:

Step 1021: determining a progress of the target cloud game at a moment of occurring the trigger operation.

To be exemplary, the cloud device firstly determines the progress of the target cloud game proactively for the target cloud game at the moment of occurring the trigger operation. The trigger operation may be a recommendation operation for acquiring the associated contents, and the progress of the target cloud game may be a game content that can reflect the game progress of the player, such as a game screen of the target cloud game, a game task performed by the player, and a game level at which the player is playing and the like at the moment of occurring the trigger operation.

Step 1022: acquiring the contents associated with the progress of the target cloud game through the data channel based on the progress of the target cloud game.

In this step, the cloud device may determine at least one preset key progress subsequent to the progress of the target cloud game based on the progress of the target cloud game; then acquire contents associated with the at least one preset key progress through the data channel and present the associated contents on the preset presentation area. The preset key progress may be a game content that can reflect the game progress of the player, such as a game screen of the target cloud game, a game task performed by the player, and a game level at which the player is playing and the like at a designated moment (which may be any moment subsequent to the moment of occurring the trigger operation).

For example, in a case where the progress of the target cloud game is a game task which the player is performing at the moment of occurring the trigger operation, the preset key progress may be a game task that the player will perform after the moment of occurring the trigger operation, and the contents associated with the target cloud game may be text guides or video guides for the game task which the player will perform after the moment of occurring the trigger operation. In this way, the contents needed by the player to play the game afterward may be proactively and accurately recommended through the game contents of the target cloud game that the player is currently playing, which improves the gaming experience of the user.

FIG. 4 is another flowchart of step 102 illustrated according to the embodiment shown in FIG. 1. As shown in FIG. 4, step 102 may also comprise:

Step 1023: superimposing, in response to the trigger operation on the interface of the target cloud game, an obscuration over the target cloud game;

Step 1024: acquiring at least one preset key progress of the target cloud game, and displaying an identifier corresponding to the at least one preset key progress on the obscuration; and

Step 1025: determining a target key progress, in response to a selecting trigger of the identifier, and acquiring contents associated with the target key progress through the data channel.

In one scenario, after the player triggering the corresponding trigger operation, the cloud device may superimpose the obscuration over the target cloud game. Subsequently, the cloud device may acquire at least one preset key progress of the target cloud game, and display at least one identifier corresponding to the at least one preset key progress on the obscuration. Then, the player may select to trigger the corresponding identifier by performing a designated operation (e.g., a clicking operation, a double-clicking operation, and a long-pressing operation, etc.) on the identifier displayed on the obscuration via the terminal according to their actual needs. Finally, in response to the selecting trigger of the identifier, the cloud device determines the preset key progress corresponding to the triggered identifier as the target key progress, then acquires contents associated with the target key progress through the preset data channel (e.g., a search engine or a preset database) and presents the associated contents on the preset presentation area.

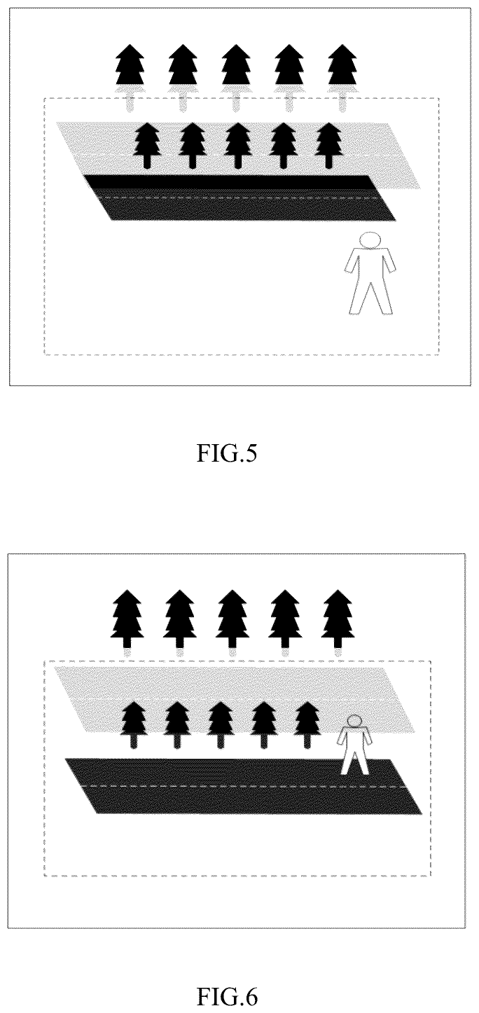

For example, in a case where the preset key progress is the game screen of the target cloud game, if the target key progress is the preset key progress at the moment of occurring the trigger operation (i.e., the target key progress is the game screen at the moment of occurring the trigger operation), at this time, the contents associated with the target key progress may be the game highlight of the player at the moment of occurring the trigger operation, and then presenting the associated contents on the preset presentation area may be as shown in FIG. 5, wherein the area surrounded by the dotted line in FIG. 5 is the game highlight of the player at the moment of occurring the trigger operation. For another example, if the target key progress is the preset key progress after the moment of occurring the trigger operation (i.e., the target key progress is the game screen after the moment of occurring the trigger operation), at this time, the contents associated with the target key progress may be the game highlight of the player after the moment of occurring the trigger operation, and then presenting the associated contents on the preset presentation area may be as shown in FIG. 6, wherein the area surrounded by the dotted line in FIG. 6 is the game highlight of the player after the moment of occurring the trigger operation.

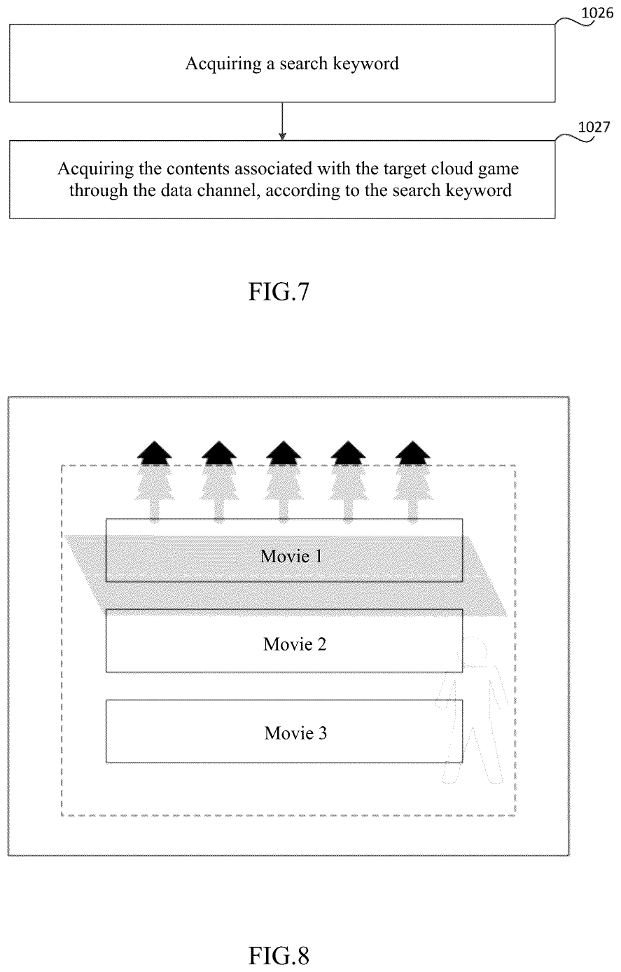

FIG. 7 is another flowchart of step 102 illustrated according to the embodiment shown in FIG. 1. As shown in the FIG. 7, the step 102 may comprise:

Step 1026: acquiring a search keyword; and

Step 1027: acquiring the contents associated with the target cloud game through the data channel, according to the search keyword.

In another scenario, the trigger operation may also be a search operation to search according to the search keyword input by the user. In particular, after receiving the trigger operation, the cloud device may, in response to the trigger operation, present a preset search box on the designated presentation area of the interface of the target cloud game to prompt the player to input the search keyword (or search text) in the preset search box. The search keyword may be the keyword related to the target cloud game, for example the “game guides”. After acquiring the search keyword, the cloud device may search to acquire the contents associated with the target cloud game through the preset data channel, according to the search keyword, and present the associated contents on the preset presentation area. In addition, the search keyword may also be a keyword that is not related to the target cloud game, e.g., when the game hangs up, the player may input a search keyword “movie” in the preset search box. Then the cloud device may search various types of movies from the network, and present various searched types of movies in the preset presentation area, as shown in FIG. 8.

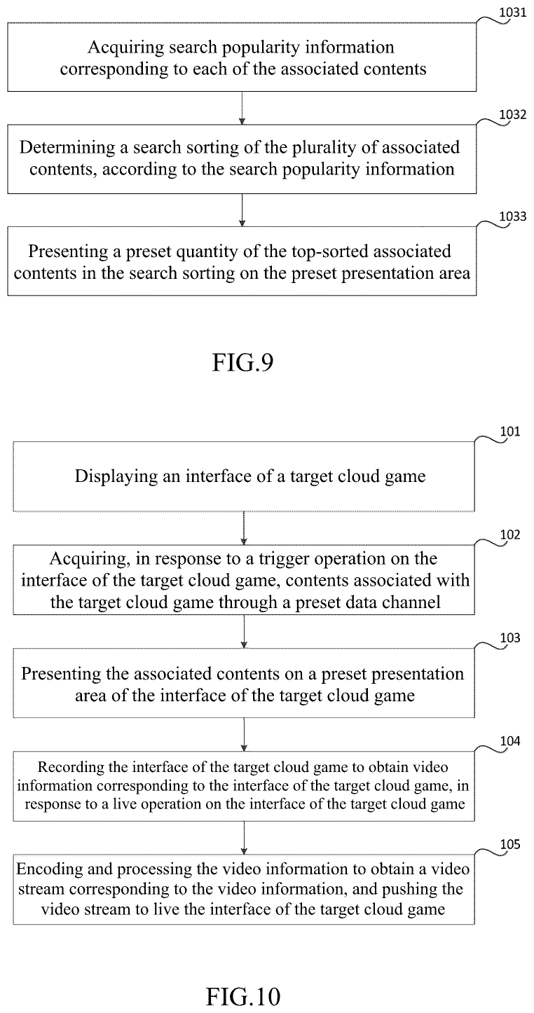

FIG. 9 is a flowchart of step 103 illustrated according to the embodiment shown in FIG. 1. As shown in FIG. 9, the associated contents are a plurality of contents, and the step 103 may comprise:

Step 1031: acquiring search popularity information corresponding to each of the associated contents;

Step 1032: determining a search sorting of the plurality of associated contents, according to the search popularity information; and

Step 1033: presenting a preset quantity of the top-sorted associated contents in the search sorting on the preset presentation area.

To be exemplary, in order to enable the player to view the desired contents associated with the target cloud game quickly and accurately, when the plurality of associated contents are acquired, the plurality of associated contents are further sorted and the sorted plurality of associated contents are presented to the player. In particular, the cloud device may firstly acquire search popularity information corresponding to each of the associated contents, and then determine the search sorting of the plurality of associated contents, according to the search popularity information. After that, the preset quantity of the top-sorted associated contents may be selected from the plurality of associated contents in the search sorting, and the preset quantity of the associated contents may be presented on the preset presentation area in the sorting of precedence.

The search popularity information corresponding to each of the associated contents may be evaluated by the click rate of the associated content from different players, in which a higher-sorted associated content is with a higher click rate.

FIG. 10 is a flowchart of another method for cloud game interaction illustrated according to an exemplary embodiment. As shown in FIG. 10, the method may also comprise:

Step 104: recording the interface of the target cloud game to obtain video information corresponding to the interface of the target cloud game, in response to a live operation on the interface of the target cloud game; and

Step 105: encoding and processing the video information to obtain a video stream corresponding to the video information, and pushing the video stream to live the interface of the target cloud game.

For example, in practice, the player often has needs of living the game. In order to meet the needs of performing the living during the game, the player may perform a preset operation on the interface of the target cloud game displayed on a client, to trigger a live operation and transmit the live operation to the cloud device. The cloud device may then, in response to the live operation on the interface of the target cloud game, directly record the interface of the target cloud game rendered by it to obtain video information, and encode and process the video information to obtain the video stream corresponding to the video information. Afterwards, the cloud device may directly push the video stream, to push the video information stream to the live server, so that the live server provides the interface of the target cloud game to the clients of other players in real time, thereby living the game interface in real time. In this way, living the game during the game does not need to rely on other APPs or Software Development Kits (SDKs), so that living the game can be performed autonomously, which improves gaming experience of the player.

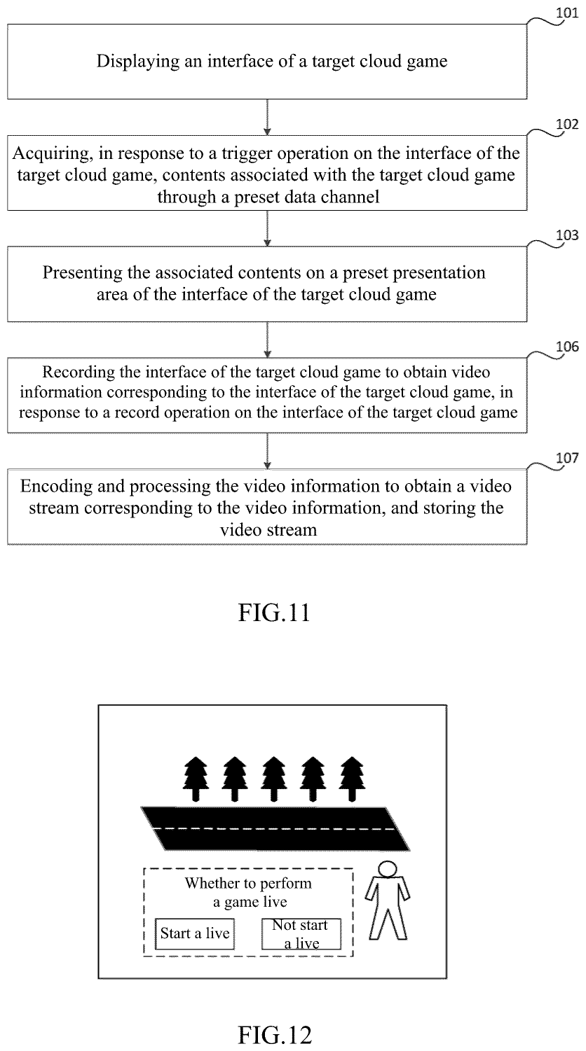

FIG. 11 is flowchart of another method for cloud game interaction illustrated according to one exemplary embodiment.

As shown in FIG. 11, the method may also comprise:

Step 106: recording the interface of the target cloud game to obtain video information corresponding to the interface of the target cloud game, in response to a record operation on the interface of the target cloud game; and

Step 107: encoding and processing the video information to obtain a video stream corresponding to the video information, and storing the video stream.

To exemplary, during the game, the player may also have needs of recording the game video. In order to meet the needs of recording the game video of the player during the game, the game may perform the preset operation on the interface of the target game displayed on a client, to trigger the record operation and transmit the record operation to the cloud device. The cloud device may then, in response to the record operation on the interface of the target cloud game, directly record the interface of the target cloud game rendered within a designated time period indicated by the record operation to obtain video information; then, encode and process the video information to obtain the video stream corresponding to the video information and store the video stream, to obtain the recorded game video within the designated time period, facilitating the player to watch or share the recorded game video within the designated time period, thereby enriching the gaming experience of the player during the game. In this way, the recording of the game video during the game does not need to rely on other APPs or SDKs, so that the game video can be recorded autonomously which improves gaming experience of the player.

Further, the cloud device may also acquire the quantity or the game popularity (e.g., the game popularity may be evaluated by the click rate) of contents of player generated contents (UGCs) of the target cloud game, and when the quantity of the contents of UGC of the target cloud game is relatively large and/or the game popularity of the target cloud game is relatively high, the player is prompted whether to share the recorded game video or perform a game live or not, in order to cause the player to record the game video or perform the game live to obtain more attentions. For example, the corresponding prompt box may be displayed on the interface of the target cloud game to prompt the player whether to share the recorded game video or perform the game live or not, as shown in FIG. 12. The player may trigger the live operation to perform the live by clicking the “Start a live” button in the prompt box.

In summary, the present disclosure firstly displays an interface of a target cloud game; acquires, in response to a trigger operation on the interface of the target cloud game, contents associated with the target cloud game through a preset data channel; and then, presents the associated contents on a preset presentation area of the interface of the target cloud game. The present disclosure may acquire the contents associated with the target cloud game directly by the trigger operation, and present the associated contents on the preset presentation area, without requiring a player to exit the game to acquire the associated contents, which may avoid affecting normal gaming experience of the player, and reduce the difficulty of acquiring the associated contents at the same time.

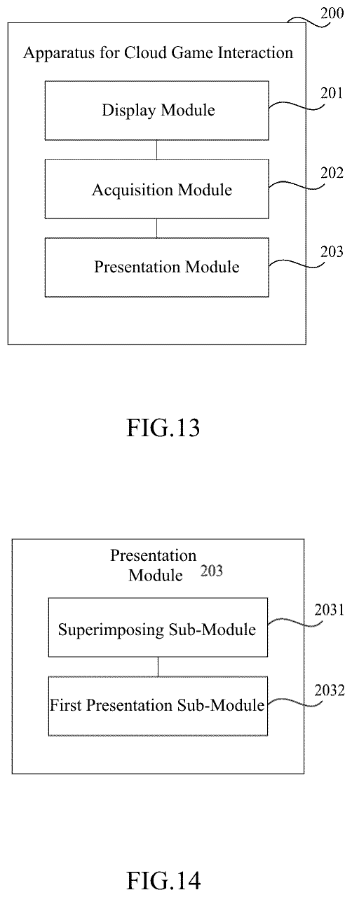

FIG. 13 is a block diagram of an apparatus for cloud game interaction illustrated according to one exemplary embodiment. As shown in the FIG. 13, the apparatus 200 may comprise:
a display module 201, configured to display an interface of a target cloud game;
an acquisition module 202, configured to acquire, in response to a trigger operation on the interface of the target cloud game, contents associated with the target cloud game through a preset data channel; and
a presentation module 203, configured to present the associated contents on a preset presentation area of the interface of the target cloud game.

FIG. 14 is a block diagram of the presentation module illustrated according to the embodiment shown in FIG. 13. As shown in the FIG. 14, the preset presentation area comprises an obscuration, and the presentation module 203 comprise:
an superimposing sub-module 2031, configured to superimpose the obscuration over the interface of the target cloud game; and
a first presentation sub-module 2032, configured to present the associated contents on the obscuration.

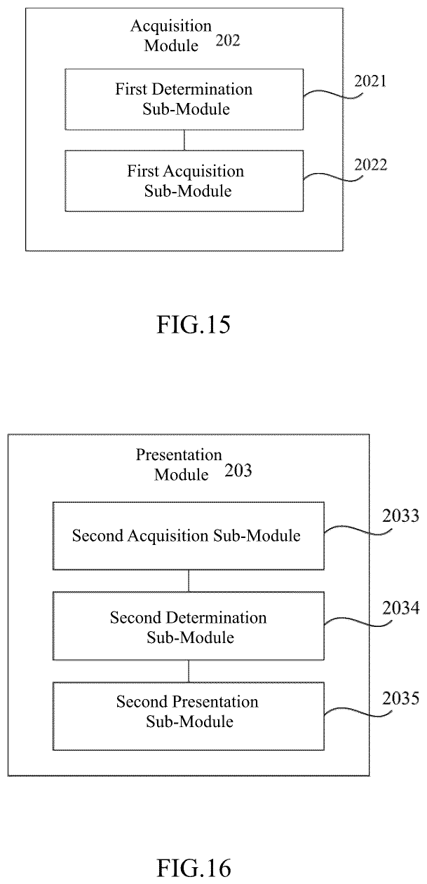

FIG. 15 is a block diagram of the acquisition module illustrated according to the embodiment shown in FIG. 13. As shown in FIG. 15, the acquisition module 202 comprises:
a first determination sub-module 2021, configured to determine a progress of the target cloud game at a moment of occurring the trigger operation; and
a first acquisition sub-module 2022, configured to acquire the contents associated with the progress of the target cloud game through the data channel based on the progress of the target cloud game.

In some embodiments, the acquisition sub-module 2022 is configured to:
determine at least one preset key progress subsequent to the progress of the target cloud game, based on the progress of the target cloud game; and
acquire contents associated with the at least one preset key progress through the data channel.

In some embodiments, the acquisition module 202 is further configured to:
superimpose, in response to the trigger operation on the interface of the target cloud game, the obscuration over the target cloud game;
acquire the at least one preset key progress of the target cloud game, and display an identifier corresponding to the at least one preset key progress on the obscuration; and
determine a target key progress in response to a selecting trigger of the identifier, and acquire contents associated with the target key progress through the data channel.

In some embodiments, the acquisition module 202 is configured to:
acquire a search keyword; and
acquire contents associated with the target cloud game through the data channel, according to the search keyword.

FIG. 16 is a block diagram of another presentation module illustrated according to the embodiment shown in FIG. 13. As shown in the FIG. 16, the presentation module 203 comprises:
a second acquisition sub-module 2033, configured to acquire search popularity information corresponding to each of the associated contents;
a second determination sub-module 2034, configured to determine a search sorting of the plurality of associated contents, according to the search popularity information; and
a second presentation sub-module 2035, configured to present a preset quantity of the top-sorted associated contents in the search sorting on the preset presentation area.

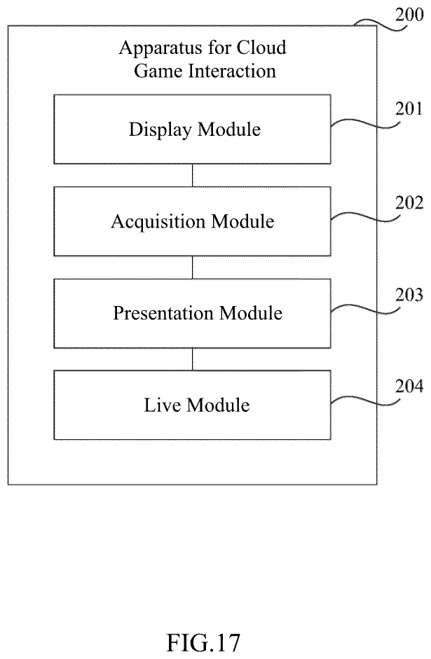

FIG. 17 is a block diagram of another apparatus for cloud game interaction illustrated according to one exemplary embodiment. As shown in the FIG. 17, the apparatus 200 may also comprise:
a live module 204, configured to record, the interface of the target cloud game to obtain video information corresponding to the interface of the target cloud game, in response to a live operation on the interface of the target cloud game.

The live module 204 is further configured to encode and process the video information to obtain a video stream corresponding to the video information, and push the video stream to live the interface of the target cloud game.

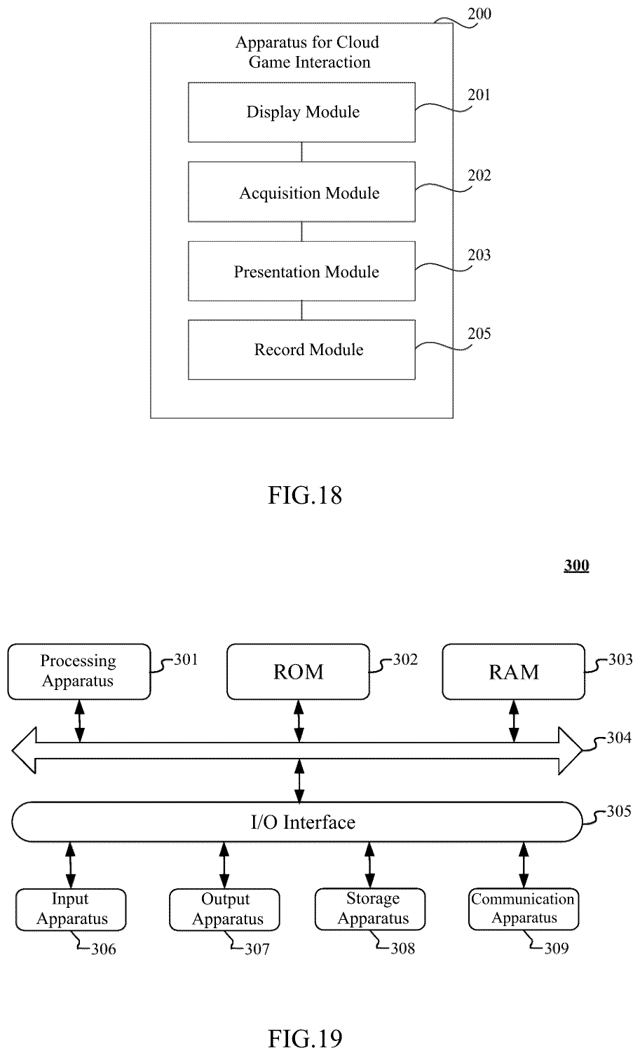

FIG. 18 is a block diagram of another apparatus for cloud game interaction illustrated according to one exemplary embodiment. As shown in the FIG. 18, the apparatus 200 may also comprise:
a record module 205, configured to record, the interface of the target cloud game to obtain video information corresponding to the interface of the target cloud game, in response to a record operation on the interface of the target cloud game.

The record module 205 is further configured to encode and process the video information to obtain a video stream corresponding to the video information, and store the video stream.

In summary, the present disclosure firstly displays an interface of a target cloud game; acquires, in response to a trigger operation on the interface of the target cloud game, contents associated with the target cloud game through a preset data channel; and then, presents the associated contents on a preset presentation area of the interface of the target cloud game. The present disclosure may acquire the contents associated with the target cloud game directly by the trigger operation, and present the associated contents on the preset presentation area, without requiring a player to exit the game to acquire the associated contents, which may avoid affecting normal gaming experience of the player, and reduce the difficulty of acquiring the associated contents at the same time.

Reference is made below to FIG. 19, which illustrates a schematic diagram of a structure of an electronic device (e.g., the server of FIG. 1) 300 suitable for implementing embodiments of the present disclosure. Terminal devices in the embodiments of the present disclosure may include, but are not limited to, mobile terminals such as mobile phones, laptop computers, digital broadcast receivers, PDAs (personal digital assistants), PADs (tablet computers), PMPs (portable multimedia players), in-vehicle terminals (e.g., in-vehicle navigation terminals), and the like, as well as fixed terminals such as digital TVs, desktop computers, and the like. The electronic device illustrated in FIG. 19 is merely an example and should not impose any limitation on the functions and scope of use of the embodiments of the present disclosure.

As shown in FIG. 19, the electronic device 300 may include a processing apparatus (e.g., a central processor, a graphics processor, etc.) 301 that may perform various appropriate actions and processes in accordance with a program stored in a read-only memory (ROM) 302 or loaded from a storage apparatus 308 into a random-access memory (RAM) 303. Also stored in the RAM 303 are various programs and data necessary for the operation of the electronic device 300. The processing apparatus 301, the ROM 302, and the RAM 303 are connected to each other via the bus 304. An input/output (I/O) interface 305 is also connected to the bus 304.

Typically, the following apparatuses may be connected to the I/O interface 305: an input apparatus 306 including, for example, a touch screen, a touch pad, a keyboard, a mouse, a camera, a microphone, an accelerometer, a gyroscope, and the like; an output apparatus 307 including, for example, a liquid crystal display (LCD), a speaker, a vibrator, and the like; a storage apparatus 308 including, for example, a magnetic tape, a hard disk, and the like; and a communication apparatus 309. The communication apparatus 309 may allow electronic device 300 to perform wireless or wired communication with other devices to exchange data. While FIG. 19 illustrates electronic device 300 with various apparatuses, it should be understood that it is not required to implement or have all of the illustrated apparatuses. More or fewer apparatuses may alternatively be implemented or possessed.

In particular, according to embodiments of the present disclosure, the process described above with reference to the flowchart may be implemented as a computer software program. For example, the embodiments of the present disclosure, which include a computer program product comprising a computer program carried on a non-transitory computer-readable medium, the computer program comprising program code for performing the method shown in the flowchart. In such embodiments, the computer program may be downloaded and installed from a network via a communication apparatus 309, or installed from a storage apparatus 308, or installed from a ROM 302. In the event that the computer program is executed by the processing apparatus 301, the above-described functions defined in the method of an embodiment of the present disclosure are performed.

It is noted that the computer-readable medium described above in the present disclosure may be a computer-readable signaling medium or a computer-readable storage medium or any combination thereof. The computer-readable storage medium may, for example, be—but is not limited to—a system, device, or apparatus, or device of electricity, magnetism, light, electromagnetism, infrared, or semiconductors, or any combination of the above. More specific examples of computer-readable storage media may include, but are not limited to: electrical connections having one or more wires, portable computer disks, hard disks, random access memory (RAM), read-only memory (ROM), erasable programmable read-only memory (EPROM or flash memory), optical fibers, portable compact disk read-only memories (CD-ROM), optical storage devices, magnetic memory device, or any suitable combination of the foregoing. In the context of the present disclosure, a computer-readable storage medium may be any tangible medium containing or storing a program that may be used by or in combination with an instruction execution system, apparatus, or device. And in the context of the present disclosure, a computer-readable signal medium may include a data signal propagated in a baseband or as part of a carrier that carries computer-readable program code. Such propagated data signals may take a variety of forms, including, but not limited to, electromagnetic signals, optical signals, or any suitable combination of the foregoing. The computer-readable signal medium may also be any computer-readable medium other than a computer-readable storage medium that sends, propagates, or transmits a program for use by, or in combination with, an instruction-executing system, apparatus, or device. The program code contained on the computer-readable medium may be transmitted using any suitable medium, including, but not limited to: wire, fiber optic cable, RF (radio frequency), etc., or any suitable combination of the foregoing.

In some implementations, a client terminal and a server may communicate utilizing any currently known or future developed network protocol such as HTTP (HyperText Transfer Protocol), and may be interconnected with digital data communications (e.g., communication networks) in any form or medium. Examples of communication networks include local area networks (“LANs”), wide area networks (“WANs”), inter-networks (e.g., the Internet), and end-to-end networks (e.g., ad hoc end-to-end networks), as well as any currently known or future developed networks.

The computer-readable medium may be contained in the electronic device; or it may stand alone and not be equipped into such electronic device.

The computer-readable medium carries one or more programs, when the one or more programs are executed by the electronic device, cause the electronic device to: display an interface of a target cloud game; acquire, in response to a trigger operation on the interface of the target cloud game, contents associated with the target cloud game through a preset data channel; present the associated contents on a preset presentation area of the interface of the target cloud game.

Computer program code for performing the operations of the present disclosure may be written in one or more programming languages, or combinations thereof, including, but not limited to, object-oriented programming languages—such as Java, Smalltalk, C++—and conventional procedural programming languages—such as the “C” language or the like.—Programming languages include, but are not limited to, object-oriented programming languages such as Java, Smalltalk, C++, but also include conventional procedural programming languages such as “C” or similar programming languages. The program code may be executed entirely on the user's computer, partially on the user's computer, as a stand-alone software package, partially on the user's computer and partially on a remote computer, or entirely on a remote computer or server. In situations involving a remote computer, the remote computer may be connected to the user's computer via any kind of network—including a local area network (LAN) or a wide area network (WAN)—or, alternatively, may be connected to an external computer (e.g., utilizing an internet Service Provider to connect via the Internet).

The flowcharts and block diagrams in the accompanying drawings illustrate the architecture, functionality, and operation of systems, methods, and computer program products that may be implemented in accordance with various embodiments of the present disclosure. At this point, each box in the flowcharts or block diagrams may represent a module, program segment, or portion of code that contains one or more executable instructions for implementing a specified logical function. It should also be noted that in some implementations as replacements, the functions labeled in the boxes may also occur in a different order than those labeled in the accompanying drawings. For example, two consecutively represented boxes may actually be executed substantially in parallel, and they may sometimes be executed in reverse order, depending on the function involved. It is also noted that each of the boxes in the block diagrams and/or flowcharts, and combinations of the boxes in the block diagrams and/or flowcharts, may be implemented with a specialized hardware-based system that performs the specified function or operation, or may be implemented with a combination of specialized hardware and computer instructions.

Modules described in embodiments of the present disclosure may be implemented by way of software or by way of hardware. the name of a module does not in some cases constitute a limitation of the module itself, for example, a display module may also be described as “a module for displaying an interface of a target cloud game”.

The functions described above herein may be performed, at least in part, by one or more hardware logic components. For example, non-limitingly, exemplary types of hardware logic components that may be used include: field programmable gate arrays (FPGAs), application-specific integrated circuits (ASICs), application-specific standard products (ASSPs), systems-on-chip (SOCs), complex programmable logic devices (CPLDs), and the like.

In the context of the present disclosure, a machine-readable medium may be a tangible medium that may contain or store a program for use by or in conjunction with an instruction execution system, device, or apparatus. The machine-readable medium may be a machine-readable signal medium or a machine-readable storage medium. The machine-readable medium may include, but is not limited to, an electronic, magnetic, optical, electromagnetic, infrared, or semiconductor system, device, or apparatus, or any suitable combination of the foregoing. More specific examples of machine-readable storage media would include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination of the foregoing. any suitable combination of the above.

According to one or more embodiments of the present application, the example 1 provides a method for cloud game interaction, the method comprising: displaying an interface of a target cloud game; acquiring, in response to a trigger operation on the interface of the target cloud game, contents associated with the target cloud game through a preset data channel; and presenting the associated contents on a preset presentation area of the interface of the target cloud game.

According to one or more embodiments of the present application, the example 2 provides the method of the example 1, wherein the preset presentation area comprising an obscuration; and wherein the presenting the associated contents on the preset presentation area of the interface of the target cloud game comprises: superimposing the obscuration over the interface of the target cloud game; and presenting the associated contents on the obscuration.

According to one or more embodiments of the present application, the example 3 provides the method of the example 1, wherein the acquiring, in response to the trigger operation on the interface of the target cloud game, the contents associated with the target cloud game through the preset data channel comprises: determining a progress of the target cloud game at a moment of occurring the trigger operation; and acquiring the contents associated with the progress of the target cloud game through the data channel based on the progress of the target cloud game.

According to one or more embodiments of the present application, the example 4 provides the method of the example 3, wherein the acquiring the contents associated with the progress of the target cloud game through the data channel based on the progress of the target cloud game, comprises: determining at least one preset key progress subsequent to the progress of the target cloud game based on the progress of the target cloud game; and acquiring contents associated with the at least one preset key progress through the data channel.

According to one or more embodiments of the present application, the example 5 provides the method of the example 1, wherein the acquiring, in response to the trigger operation on the interface of the target cloud game, the contents associated with the target cloud game through the preset data channel, further comprises: superimposing, in response to a trigger operation on the interface of the target cloud game, an obscuration over the target cloud game; acquiring at least one preset key progress of the target cloud game, displaying an identifier corresponding to the at least one preset key progress on the obscuration; determining a target key progress in response to a selecting trigger of the identifier, and acquiring contents associated with the target key progress through the data channel.

According to one or more embodiments of the present application, the example 6 provides the method of the example 1, wherein the acquiring, in response to the trigger operation on the interface of the target cloud game, the contents associated with the target cloud game through the preset data channel, comprises: acquiring a search keyword; and acquiring contents associated with the target cloud game through the data channel, according to the search keyword.

According to one or more embodiments of the present application, the example 7 provides the method of the example 1, wherein the associated contents are a plurality of associated contents, and wherein the presenting the associated contents on the preset presentation area of the interface of the target cloud game comprises: acquiring search popularity information corresponding to each of the associated contents; determining a search sorting of the plurality of associated contents, according to the search popularity information; and presenting a preset quantity of the top-sorted associated contents in the search sorting on the preset presentation area.

According to one or more embodiments of the present application, the example 8 provides the method of the example 1, the method further comprising: recording the interface of the target cloud game to obtain video information corresponding to the interface of the target cloud game, in response to a live operation on the interface of the target cloud game; encoding and processing the video information to obtain a video stream corresponding to the video information, and pushing the video stream to live the interface of the target cloud game.

According to one or more embodiments of the present application, the example 9 provides the method of the example 1, the method further comprising: recording the interface of the target cloud game to obtain video information corresponding to the interface of the target cloud game in response to a record operation on the interface of the target cloud game; encoding and processing the video information to obtain a video stream corresponding to the video information, and storing the video stream.

According to one or more embodiments of the present application, the example 10 provides an apparatus for cloud game interaction, the apparatus comprising: a display module, configured to display an interface of a target cloud game; an acquisition module, configured to acquire, in response to a trigger operation on the interface of the target cloud game, contents associated with the target cloud game through a preset data channel; and a presentation module, configured to present the associated contents on a preset presentation area of the interface of the target cloud game.

According to one or more embodiments of the present application, the example 11 provides a computer-readable medium having a computer program stored thereon, when executed by a processing apparatus, the program implementing the steps of the method described in the example 1 to example 9.

According to one or more embodiments of the present application, the example 12 provides an electronic device, comprising: a storage apparatus, having a computer program stored thereon; a processing apparatus, configured to execute the computer program in the storage apparatus to implement the steps of the method described in the example 1 to example 9.

The above description is only a preferred embodiment of the present disclosure and an illustration of the technical principles applied. It should be understood by those skilled in the art that the scope of the disclosure involved in the present disclosure is not limited to technical solutions formed by a particular combination of the above technical features, but also covers other technical solutions formed by any combination of the above technical features or their equivalent without departing from the above disclosed concept. For example, a technical solution formed by interchanging the above features with (but not limited to) technical features having similar functions disclosed in the present disclosure.

Furthermore, while the operations are depicted using a particular order, this should not be construed as requiring that the operations be performed in the particular order shown or in a sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in a plurality of embodiments, either individually or in any suitable sub-combination.

Although the present subject matter has been described using language specific to structural features and/or method logic actions, it should be understood that the subject matter defined in the appended claims is not necessarily limited to the particular features or actions described above. Rather, the particular features and actions described above are merely exemplary forms of implementing the claims. With respect to the apparatus in the above embodiment, the specific manner in which each module performs an operation has been described in detail in the embodiments relating to the method, and will not be described in detail herein.

1. A method for cloud game interaction, the method comprising:
displaying an interface of a target cloud game;
acquiring, in response to a trigger operation on the interface of the target cloud game, contents associated with the target cloud game through a preset data channel; and
presenting the associated contents on a preset presentation area of the interface of the target cloud game.

2. The method of claim 1, wherein the preset presentation area comprises an obscuration; and wherein the presenting the associated contents on the preset presentation area of the interface of the target cloud game comprises:
superimposing the obscuration over the interface of the target cloud game; and
presenting the associated contents on the obscuration.

3. The method of claim 1, wherein the acquiring, in response to the trigger operation on the interface of the target cloud game, the contents associated with the target cloud game through the preset data channel comprises:
determining a progress of the target cloud game at a moment of occurring the trigger operation; and
acquiring contents associated with the progress of the target cloud game through the data channel based on the progress of the target cloud game.

4. The method of claim 3, wherein the acquiring the contents associated with the progress of the target cloud game through the data channel based on the progress of the target cloud game comprises:
determining at least one preset key progress subsequent to the progress of the target cloud game, based on the progress of the target cloud game; and
acquiring contents associated with the at least one preset key progress through the data channel.

5. The method of claim 1, wherein the acquiring, in response to the trigger operation on the interface of the target cloud game, the contents associated with the target cloud game through the preset data channel, further comprises:
superimposing, in response to the trigger operation on the interface of the target cloud game, an obscuration over the target cloud game;
acquiring at least one preset key progress of the target cloud game;
displaying an identifier corresponding to the at least one preset key progress on the obscuration;
determining a target key progress, in response to a selecting trigger of the identifier, and
acquiring contents associated with the target key progress through the data channel.

6. The method of claim 1, wherein the acquiring, in response to the trigger operation on the interface of the target cloud game, the contents associated with the target cloud game through the preset data channel comprises:
acquiring a search keyword; and
acquiring the contents associated with the target cloud game through the data channel, according to the search keyword.

7. The method of claim 1, wherein the associated contents are a plurality of associated contents, and wherein the presenting the associated contents on the preset presentation area of the interface of the target cloud game comprises:
acquiring search popularity information corresponding to each of the associated contents;
determining a search sorting of the plurality of associated contents, according to the search popularity information; and
presenting a preset quantity of the top-sorted associated contents in the search sorting on the preset presentation area.

8. The method of claim 1, the method further comprising:
recording, the interface of the target cloud game to obtain video information corresponding to the interface of the target cloud game, in response to a live operation on the interface of the target cloud game;
encoding and processing the video information to obtain a video stream corresponding to the video information, and
pushing the video stream to live the interface of the target cloud game.

9. The method of claim 1, the method further comprising:
recording the interface of the target cloud game to obtain video information corresponding to the interface of the target cloud game, in response to a record operation on the interface of the target cloud game; and
encoding and processing the video information to obtain a video stream corresponding to the video information, and
storing the video stream.

10.-11. (canceled)

12. An electronic device, comprising:
a storage apparatus, having a computer program stored thereon;
a processing apparatus, configured to execute the computer program in the storage apparatus to:
display an interface of a target cloud game;
acquire, in response to a trigger operation on the interface of the target cloud game, contents associated with the target cloud game through a preset data channel; and
present the associated contents on a preset presentation area of the interface of the target cloud game.

13. The electronic device of claim 12, wherein the preset presentation area comprises an obscuration; and wherein to present the associated contents on the preset presentation area of the interface of the target cloud game, the processing apparatus is configured to execute the computer program in the storage apparatus to:
superimpose the obscuration over the interface of the target cloud game; and
present the associated contents on the obscuration.

14. The electronic device of claim 12, wherein to acquire, in response to the trigger operation on the interface of the target cloud game, the contents associated with the target cloud game through the preset data channel, the processing apparatus is configured to execute the computer program in the storage apparatus to:
determine a progress of the target cloud game at a moment of occurring the trigger operation; and
acquire contents associated with the progress of the target cloud game through the data channel based on the progress of the target cloud game.

15. The electronic device of claim 14, wherein to acquire the contents associated with the progress of the target cloud game through the data channel based on the progress of the target cloud game, the processing apparatus is configured to execute the computer program in the storage apparatus to:
determine at least one preset key progress subsequent to the progress of the target cloud game, based on the progress of the target cloud game; and
acquire contents associated with the at least one preset key progress through the data channel.

16. The electronic device of claim 12, wherein to acquire, in response to the trigger operation on the interface of the target cloud game, the contents associated with the target cloud game through the preset data channel, the processing apparatus is configured to execute the computer program in the storage apparatus further to:
superimpose, in response to the trigger operation on the interface of the target cloud game, an obscuration over the target cloud game;
acquire at least one preset key progress of the target cloud game;
display an identifier corresponding to the at least one preset key progress on the obscuration;
determine a target key progress, in response to a selecting trigger of the identifier, and
acquire contents associated with the target key progress through the data channel.

17. The electronic device of claim 12, wherein to acquire, in response to the trigger operation on the interface of the target cloud game, the contents associated with the target cloud game through the preset data channel, the processing apparatus is configured to execute the computer program in the storage apparatus to:
acquire a search keyword; and
acquire the contents associated with the target cloud game through the data channel, according to the search keyword.

18. The electronic device of claim 12, wherein the associated contents are a plurality of associated contents, and wherein to present the associated contents on the preset presentation area of the interface of the target cloud game, the processing apparatus is configured to execute the computer program in the storage apparatus to:
acquire search popularity information corresponding to each of the associated contents;
determine a search sorting of the plurality of associated contents, according to the search popularity information; and
present a preset quantity of the top-sorted associated contents in the search sorting on the preset presentation area.

19. The electronic device of claim 12, the processing apparatus configured to execute the computer program in the storage apparatus further to:
record, the interface of the target cloud game to obtain video information corresponding to the interface of the target cloud game, in response to a live operation on the interface of the target cloud game;
encode and process the video information to obtain a video stream corresponding to the video information, and
push the video stream to live the interface of the target cloud game.

20. The electronic device of claim 12, the processing apparatus configured to execute the computer program in the storage apparatus further to:
record the interface of the target cloud game to obtain video information corresponding to the interface of the target cloud game, in response to a record operation on the interface of the target cloud game; and
encode and process the video information to obtain a video stream corresponding to the video information, and
store the video stream.

21. A computer-readable medium having a computer program stored thereon, when executed by a processing apparatus, the program implementing the steps of:
displaying an interface of a target cloud game;
acquiring, in response to a trigger operation on the interface of the target cloud game, contents associated with the target cloud game through a preset data channel; and
presenting the associated contents on a preset presentation area of the interface of the target cloud game.

22. The computer-readable medium of claim 19, wherein the preset presentation area comprises an obscuration; and wherein the presenting the associated contents on the preset presentation area of the interface of the target cloud game comprises:
superimposing the obscuration over the interface of the target cloud game; and
presenting the associated contents on the obscuration.
